(19) United States
(12) Patent Application Publication
(10) Pub. No.: US 2009/0149231 A1
(43) Pub. Date: Jun. 11, 2009

(54) RADIO APPARATUS AND BUILT-IN ANTENNA DEVICE

(75) Inventor: Koichi Sato, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/142,079

(22) Filed: Jun. 19, 2008

(30) Foreign Application Priority Data
Dec. 5, 2007 (JP) 2007-315131

(51) Int. Cl. H04M 1/00

(52) U.S. Cl. 455/575.7

(57) ABSTRACT

A radio apparatus having a first housing section and a second housing section is provided. The radio apparatus has a printed board contained in the second housing. The printed board is provided with an antenna feeding circuit. The radio apparatus has a hinge section pivotally connecting the first housing section and the second housing section to each other so as to relatively rotate the first housing section and the second housing section. The hinge section includes a spring, a non-conductive portion and a conductive portion other than the spring. The conductive portion is connected to the antenna feeding circuit.

### CROSS REFERENCE TO RELATED APPLICATIONS

This application is based upon and claims the benefit of priority from the prior Japanese Patent Application No. 2007-315131 filed on Dec. 5, 2007; the entire contents of which are incorporated herein by reference.

### BACKGROUND OF THE INVENTION

1. Field of the Invention

The present invention relates to a radio apparatus and a built-in antenna device and in particular to a radio apparatus including two housing sections and an antenna device of the radio apparatus.

2. Description of the Related Art

Most of radio apparatus such as mobile phones these days are formed by two housing sections connected to each other and configured to be opened or closed in order to satisfy requirements of multiple functions, high performance, downsizing and small thickness at once.

Two housing sections may be connected in a clamshell (or flip) type structure, a slide type structure or a dual hinge flip (or double swivel) type structure. Among the above structures, the clamshell or double swivel type structure includes a hinge section by which the two housing sections are pivotally connected.

Meanwhile, most of antenna devices of radio apparatus such as mobile phones these days are of built-in types rather than conventional types such as whip antennas to be extended outside housings. By using such built-in antenna devices radio apparatus may be improved in aesthetic or operational aspects.

As the radio apparatus face the above requirements of multiple functions, high performance, downsizing and small thickness of the radio apparatus at once, though, the antenna devices have to satisfy required performance while being mounted in a limited mounting space inside the housings.

In order to meet the above requirements, a mobile radio apparatus having an antenna arranged in a hinge section is disclosed in Japanese Patent Publication of Unexamined Applications (Kokai), No. 2007-88692. The mobile radio apparatus of JP 2007-88692 is formed by a first (housing) section and a second (housing) section which are pivotally connected to each other by the hinge section. A hinge core forming a hinge axis is arranged in the hinge section.

More specifically, the hinge core is formed by a first material and a second material connected to each other. The first material is mechanically fixed in the second section and electrically connected to a circuit board of the second section. The second material is mechanically fixed in the first section but is not electrically connected to a circuit board of the first section.

The first material is shaped into a cylinder or a column and made of conductive material such as metal, and so is the second material. In such a configuration, the hinge core may be fed as an antenna element from the circuit board of the second section, while being disconnected to the circuit board of the first section.

The above hinge core of the mobile radio apparatus of JP 2007-88692 which forms the hinge axis is entirely made of the conductive material and may be fed as the antenna element. According to a paragraph “0026” of JP 2007-88692, the hinge core is formed by the first material on the second section side and the first material on the first section side.

The above first material and the second material are shaped into a cylinder or a column and made of conductive material such as metal, and mechanically connected to each other in such a manner that the first material may rotate against the second material and vice versa. The hinge core has a mechanism to generate resistance power to give a click feeling at a given position of rotation and a mechanism to generate power of rotation by itself.

In order to generate power of rotation by itself, a spiral shaped spring may be provided in a direction of a rotation axis to give resistance power to reverse rotation. As being made of metal and thus conductive in general, the spring may affect an antenna characteristic if being deformed by an open or closed state depending on relative rotation between the first section and the second section. As the mobile radio apparatus may generally change the open or closed state depending on applications, it should be avoided that the antenna characteristic is affected as described above.

### SUMMARY OF THE INVENTION

Accordingly, an object of the present invention is to form an antenna device of a radio apparatus by using materials of a hinge section pivotally connecting two housing sections of the radio apparatus, which may avoid being much affected by an open or closed state depending on relative rotation between the two housing sections.

To achieve the above object, according to one aspect of the present invention, a radio apparatus having a first housing section and a second housing section is provided. The radio apparatus has a printed board contained in the second housing. The printed board is provided with an antenna feeding circuit. The radio apparatus has a hinge section pivotally connecting the first housing section and the second housing section to each other so as to relatively rotate the first housing section and the second housing section. The hinge section includes a spring, a non-conductive portion and a conductive portion other than the spring. The conductive portion is connected to the antenna feeder circuit.

### BRIEF DESCRIPTION OF THE DRAWINGS

FIG. 1 is a perspective view of a main portion of a radio apparatus of a first embodiment of the present invention.

FIG. 2 is a perspective view showing a configuration of a hinge section of the radio apparatus of the first embodiment.

FIG. 3 is a perspective view of the radio apparatus of the first embodiment showing an electric connection to feed a conductive portion of the hinge section.

FIG. 4 is a perspective view showing a configuration of a model for estimating a characteristic of an antenna device of the first embodiment by simulation.

FIG. 5 is a graph of a frequency characteristic of a voltage standing wave ratio (VSWR) of the model of FIG. 4 estimated by simulation.

FIG. 6 is a perspective view showing a configuration of a main portion and connections of a radio apparatus of a second embodiment of the present invention.

FIG. 7 is a perspective view showing a configuration of a model for estimating a characteristic of an antenna device of the second embodiment by simulation.

FIG. 8 is a graph of a frequency characteristic of a VSWR of the model of FIG. 4 estimated by simulation.

FIG. 9 is a perspective view showing a configuration of a main portion and connections of a radio apparatus of a third embodiment of the present invention.

FIG. 10 is a cross section of a spring portion included in a hinge section of the radio apparatus of the third embodiment.

FIG. 11 is a perspective view showing a configuration of a main portion and connections of a radio apparatus of a modification of the above embodiments.

FIG. 12 is a perspective view showing a configuration of a main portion and connections of a radio apparatus of another modification of the above embodiments.

### DETAILED DESCRIPTION OF THE INVENTION

Hereinafter, embodiments of the present invention will be described in detail. In following descriptions, terms such as upper, lower, left, right, horizontal or vertical used while referring to a drawing shall be interpreted on a page of the drawing unless otherwise noted. Besides, a same reference numeral given in no less than two drawings shall represent a same member or a same portion.

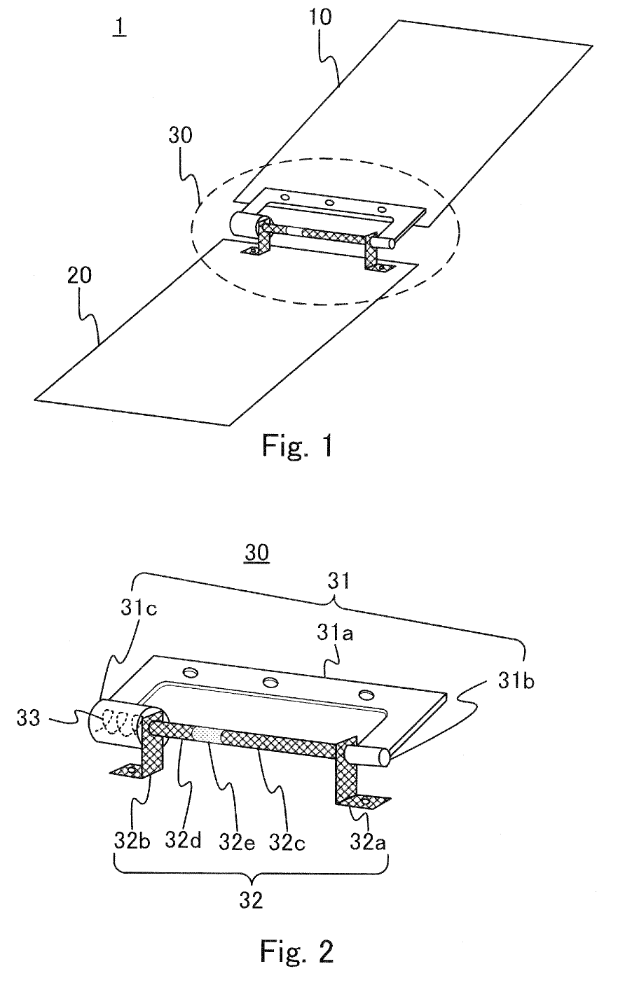

A first embodiment of the present invention will be described with reference to FIGS. 1-5. FIG. 1 is a perspective view of a main portion of a radio apparatus 1 of the first embodiment. The radio apparatus 1 is formed by a first (housing) section 10 and a second (housing) section 20 which are pivotally connected to each other by a hinge section 30 (encircled by a dotted ellipse) so as to relatively rotate.

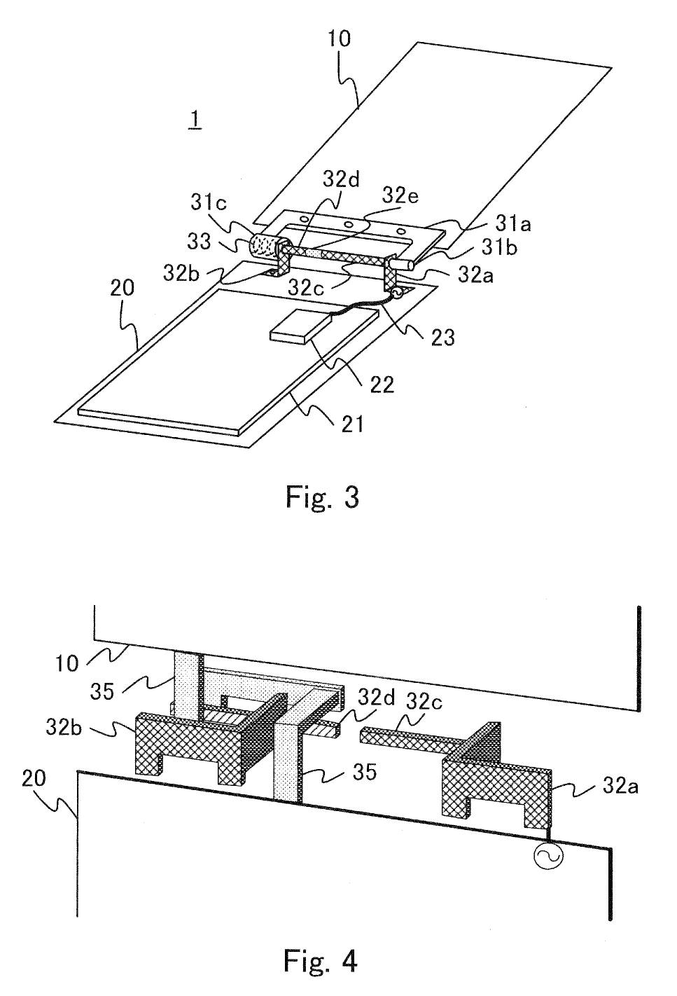

In FIG. 1, the first section 10 and the second section 20 are shown like planes for simplicity of the drawing (and also in FIG. 3 and FIG. 6 referred to later). As described later with reference to FIG. 3, the second section 20 contains a printed board 21 (not shown in FIG. 1).

FIG. 2 is a perspective view showing a configuration of the hinge section 30. The hinge section 30 has a first section side material 31 (indicated without hatching, and shortened as the first material 31) and a second section side material 32 (indicated with hatching, and shortened as the second material 32).

The first material 31 has a first fitting portion 31a shaped into a flat plate and having fitting holes, a bearing portion 31b shaped into, e.g., a cylinder on a right side, and a spring portion 31c shaped into, e.g., a cylinder on a left side. The first fitting portion 31a, the bearing portion 31b and the spring portion 31c are made of non-conductive material.

The first fitting portion 31a, the bearing portion 31b and the spring portion 31c forming the first material 31 have no moving portion between one another and are mechanically fixed to one another. The first fitting portion 31a may be, e.g., screwed to the first section 10 through the fitting holes so that the first material 31 may be mechanically fixed to the first section 10.

The second material 32 has a second fitting portion 32a being L-shaped and indicated with mesh hatching on a right side, and a second fitting portion 32b being inverse L-shaped and indicated with mesh hatching on a left side. The second material 32 has a shaft conductive portion 32c shaped into a shaft indicated with mesh hatching on a right side, a shaft conductive portion 32d shaped into a shaft indicated with mesh hatching on a left side, and a shaft non-conductive portion 32e shaped into a shaft indicated with light hatching. The second fitting portion 32a, the second fitting portion 32b, the shaft conductive portion 32c and the shaft conductive portion 32d are made of conductive material. The shaft non-conductive portion 32e is made of non-conductive material.

The second fitting portion 32a, the second fitting portion 32b, the shaft conductive portion 32c, the shaft conductive portion 32d and the shaft non-conductive portion 32e forming the second material 32 have no moving portion between one another and are mechanically fixed to one another. The second fitting portions 32a and 32b may be, e.g., screwed to the second section 20 so that the second material 32 may be mechanically fixed to the second section 20.

Being hollow inside, e.g., shaped into a hollow cylinder, the bearing portion 31b contains a right-hand end (not shown) of the shaft conductive portion 32c. Being hollow inside, e.g., shaped into a hollow cylinder, the spring portion 31c accommodates a spiral shaped spring 33 (shown by a dotted line) and a left-hand end (not shown) of the shaft conductive portion 32d penetrates the spiral of the spring 33.

The shaft conductive portions 32c and 32d and the shaft non-conductive portion 32e form a single shaft which may be supported by the bearing portion 31b and the spring portion 31c and may rotate around an axis of the shaft. Depending on such structure of the hinge section 30, the first section 10 and the second section 20 are pivotally connected to each other so as to relatively rotate around the axis of the shaft and to be relatively open or closed.

Generating rotational resistance power to the above relative rotation, the spring 33 contained in the spring portion 31c may, e.g., give a moderate resistance feeling while the first section 10 and the second section 20 are being relatively closed, or may give an operational feeling that the first section 10 and the second section 20 are being relatively opened by themselves to a certain degree. The spring portion 31c may have a mechanism to give a moderate click feeling to an operation of relatively opening or closing the first section 10 and the second section 20.

FIG. 3 is a perspective view of the radio apparatus 1 showing an electric connection to feed the shaft conductive portion 32c as an antenna through the second fitting portion 32a. The printed board 21 is provided in the second section 20. A radio circuit 22 is mounted on the printed board 21.

The radio circuit 22 is connected to the second fitting portion 32a by a feeder line 23 such as, e.g., a coaxial cable. That is, the radio circuit 22 and the feeder line 23 form an antenna feeding circuit, and a lower end of the second fitting portion 32a becomes a feeding portion. As each of other portions shown in FIG. 3 is a same as the corresponding one shown in FIG. 1 or FIG. 2 and given a same reference numeral, its explanation is omitted.

Depending on the connection described above, the radio circuit 22 may feed and excite the second fitting portion 32a and the shaft conductive portion 32c as an antenna element. If being fed in an unbalanced manner, the antenna element may form an antenna device which may also use an unbalanced current flowing on a ground conductor (not shown) of the printed board 21 as a radiation source of an electromagnetic wave.

Assume that the above shaft of the hinge section 30 is entirely made of conductive material and is fed as an antenna element, which is then arranged close to the spring 33 contained in the spring portion 31c. Being made of conductive material and changing a shape as the first section 10 and the second section 20 relatively rotate, the spring 33 may affect antenna characteristics.

Depending on the configuration of the first embodiment described above, as the shaft conductive portion 32c and the second fitting portion 32a being farther from the spring 33 within the shaft of the hinge section 30 are used as the antenna element, the change of the shape of the spring 33 may less affect the antenna characteristics.

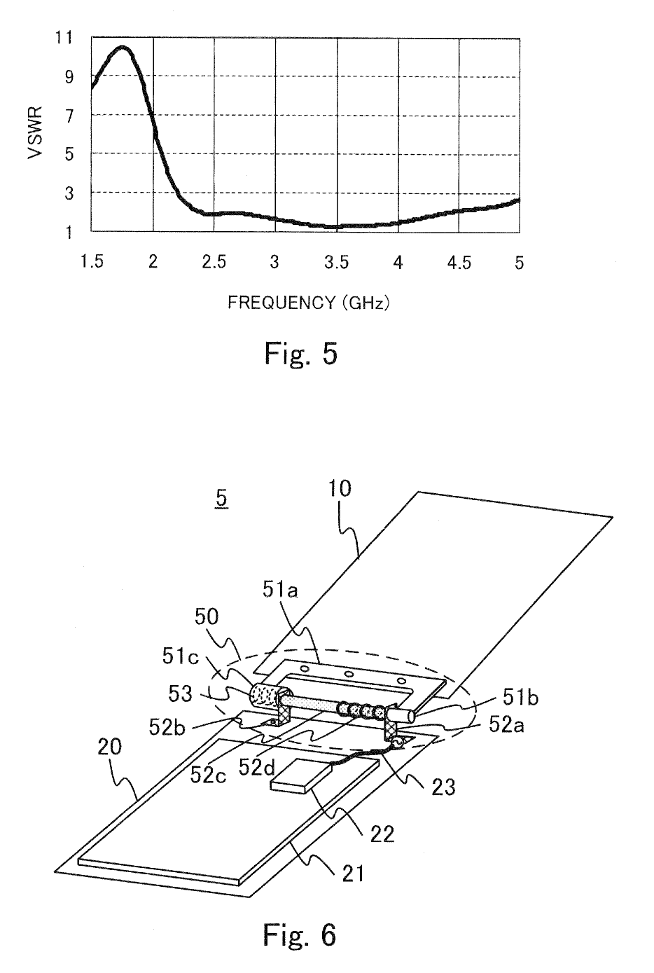

One of the antenna characteristics of the first embodiment will be explained with reference to FIG. 4 and FIG. 5. FIG. 4 is a perspective view showing a configuration of a model for estimating the characteristic of the antenna device by simulation. Each of portions given the reference numerals 10, 20, 32a-32d and a relative position between one another are same as in FIG. 3, except for slight changes of their shapes.

Only portions of the first section 10 and the second section 20 near the hinge section 30 are shown in FIG. 4. A gap between the shaft conductive portions 32c and 32d shown in FIG. 4 corresponds to the shaft non-conductive portion 32e.

A component given a reference numeral 35 in FIG. 4 is a connection material such as, e.g., a flexible printed board arranged through the hinge section 30. The connection material 35 goes through a portion of the hinge section 30 near the second fitting portion 32b and the shaft conductive portion 32d. As shown in FIG. 4, and also in FIG. 3, the connection material 35 goes through a portion of the hinge section 30 near the spring 33 (not shown in FIG. 4) contained in the spring portion 31c of the hinge section 30.

Depending on the configuration shown in FIG. 4, the connection material 35 is arranged to go through a portion of the hinge section 30 being farther from the second fitting portion 32a and the shaft conductive portion 32c both of which may be excited as the antenna element, and interference between electric signals going through the connection material 35 and the antenna element may be reduced, thereby.

FIG. 5 is a graph of a frequency characteristic of a voltage standing wave ratio (VSWR) at the feeding portion of the model of FIG. 4 estimated by simulation. FIG. 5 has a horizontal axis representing frequencies in gigahertz (GHz), and a vertical axis representing the VSWR. As shown in FIG. 5, the model shows good performance of the VSWR, i.e., no greater than three, in a frequency range from 2.2 to 5 GHz, and thus may be used as an antenna of a wireless local area network (WLAN), Bluetooth™, an ultra-wide band (UWB) system and so forth.

According to the first embodiment of the present invention described above, the shaft around which the two sections of the radio apparatus relatively rotate may be divided into the conductive and non-conductive portions. By using as the antenna element the conductive portion arranged farther from the spring which may change the shape depending on the open or closed state, the radio apparatus may enjoy the antenna characteristic which may be less affected by the open or closed state as well as efficiency of mounting space.

A second embodiment of the present invention will be described with reference to FIGS. 6-8. FIG. 6 is a perspective view showing a configuration of a main portion and connections of a radio apparatus 5 of the second embodiment. The radio apparatus 5 is formed by the first section 10 and the second section 20 which are same as the ones of the first embodiment, and are pivotally connected to each other by a hinge section 50 (encircled by a dotted ellipse) so as to relatively rotate. The second section 20 contains the printed board 21 which is a same as the one of the first embodiment.

The hinge section 50 has a first section side material 51 (indicated without hatching, and shortened as the first material 51) and a second section side material 52 (indicated with hatching, and shortened as the second material 52).

The first material 51 has a first fitting portion 51a shaped into a flat plate and having fitting holes, a bearing portion 51b shaped into, e.g., a cylinder on a right side, and a spring portion 51c shaped into, e.g., a cylinder on a left side. The first fitting portion 51a, the bearing portion 51b and the spring portion 51c are made of non-conductive material.

The first fitting portion 51a, the bearing portion 51b and the spring portion 51c forming the first material 51 have no moving portion between one another and are mechanically fixed to one another. The first fitting portion 51a may be, e.g., screwed to the first section 10 through the fitting holes so that the first material 51 may be mechanically fixed to the first section 10. It may be obviously considered that the first material 51 is a same as the first material 31 of the first embodiment.

The second material 52 has a second fitting portion 52a being L-shaped and indicated with mesh hatching on a right side, a second fitting portion 52b being inverse L-shaped and indicated with mesh hatching on a left side, and a shaft portion 52c which is shaped into a shaft indicated with light hatching.

The shaft portion 52c is made of non-conductive material. On a surface of the shaft portion 52c, a conductive pattern 52d is formed to be, e.g., helical or a spiral. An end of the conductive pattern 52d is connected to the second fitting portion 52a.

The second fitting portion 52a, the second fitting portion 52b and the shaft portion 52c forming the second material 52 have no moving portion between one another and are mechanically fixed to one another. The second fitting portions 52a and 52b may be, e.g., screwed to the second section 20 so that the second material 52 may be mechanically fixed to the second section 20.

Being hollow inside, e.g., shaped into a hollow cylinder, the bearing portion 51b contains a right-hand end (not shown) of the shaft portion 52c. Being hollow inside, e.g., shaped into a hollow cylinder, the spring portion 51c accommodates a spiral shaped spring 53 (shown by a dotted line) and a left-hand end (not shown) of the shaft portion 52c penetrates the spiral of the spring 53.

The shaft portions 52c form a single shaft which may be supported by the bearing portion 51b and the spring portion 51c and may rotate around an axis of the shaft. Depending on such structure of the hinge section 50, the first section 10 and the second section 20 are pivotally connected to each other so as to relatively rotate around the axis of the shaft and to be relatively open or closed.

As described with respect to the first embodiment, generating resistance power in the above relative rotation, the spring 53 contained in the spring portion 51c may, e.g., give a moderate resistance feeling while the first section 10 and the second section 20 are being relatively closed, or may give an operational feeling that the first section 10 and the second section 20 are being relatively opened by themselves to a certain degree. The spring portion 51c may have a mechanism to give a moderate click feeling to an operation of relatively opening or closing the first section 10 and the second section 20.

As described with respect to the first embodiment, the radio circuit 22 is provided in the printed board 21. The radio circuit 22 is connected to the second fitting portion 52a by the feeder line 23 such as, e.g., a coaxial cable. That is, the radio circuit 22 and the feeder line 23 form an antenna feeding circuit, and a lower end of the second fitting portion 52a becomes a feeding portion.

Depending on the connection described above, the radio circuit 22 may feed and excite the second fitting portion 52a and the conductive pattern 52d as an antenna element. If being fed in an unbalanced manner, the antenna element may form an antenna device which may also use an unbalanced current flowing on a ground conductor (not shown) of the printed board 21 as a radiation source of an electromagnetic wave.

Depending on the configuration of the above antenna device, as the conductive pattern 52d and the second fitting portion 52a being farther from the spring 53 within the shaft of the hinge section 50 are used as the antenna element, a change of a shape of the spring 53 may less affect antenna characteristics.

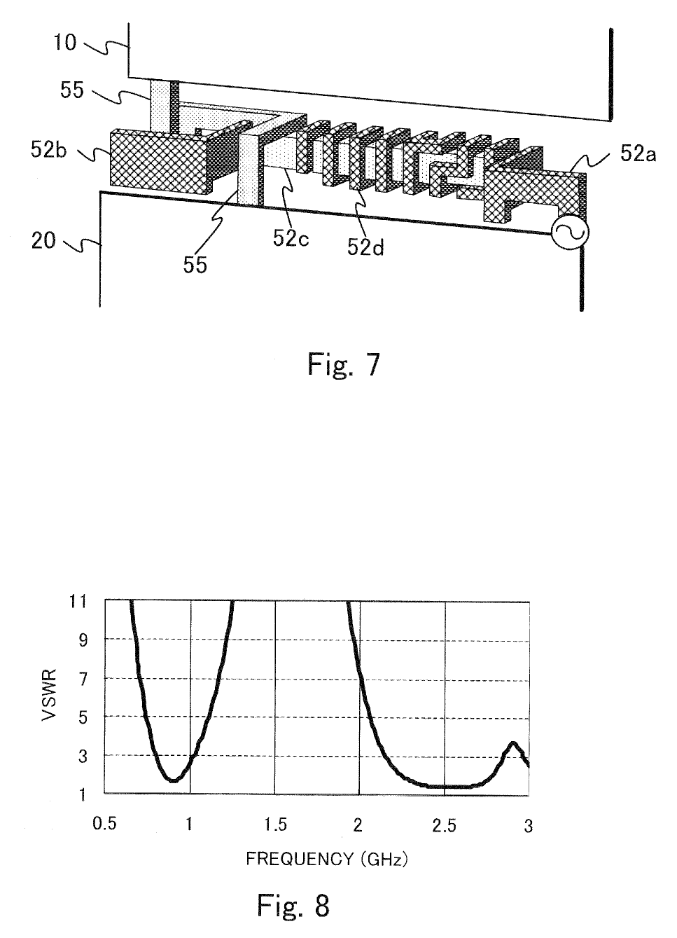

One of the antenna characteristics of the second embodiment will be explained with reference to FIG. 7 and FIG. 8. FIG. 7 is a perspective view showing a configuration of a model for estimating the characteristic of the antenna device by simulation. Each of portions given the reference numerals 10, 20, 52a-52d and a relative position between one another are same as in FIG. 6, except for slight changes of their shapes. Only portions of the first section 10 and the second section 20 near the hinge section 30 are shown in FIG. 7.

A component given a reference numeral 55 in FIG. 7 is a connection material such as, e.g., a flexible printed board arranged through the hinge section 50. The connection material 55 goes through a portion of the hinge section 50 near the second fitting portion 52b. As shown in FIG. 7, and also in FIG. 6, the connection material 55 goes through a portion of the hinge section 50 near the spring 53 (not shown in FIG. 7) contained in the spring portion 51c of the hinge section 50.

Depending on the configuration shown in FIG. 7, the connection material 55 is arranged going through a portion of the hinge section 50 being farther from the second fitting portion 52a and the conductive pattern 52d both of which may be excited as the antenna element, and interference between electric signals going through the connection material 55 and the antenna element may be reduced thereby.

FIG. 8 is a graph of a frequency characteristic of a VSWR at the feeding portion of the model of FIG. 7 estimated by simulation. FIG. 8 has a horizontal axis representing frequencies in GHz, and a vertical axis representing the VSWR. As shown in FIG. 8, the model shows good performance of the VSWR, i.e., no greater than three, in a frequency range at and above 2.2.GHz, and in an 800 MHz band (one of frequency bands assigned to cellular phone services) as well.

According to the second embodiment of the present invention described above, the shaft around which the two sections of the radio apparatus relatively rotate is formed by non-conductive material. By using as the antenna element the conductive pattern formed on the surface of the portion of the shaft being farther from the spring which may change the shape depending on the open or closed state, the radio apparatus may enjoy the antenna characteristic which may be less affected by the open or closed state as well as efficiency of mounting space.

By selecting a length or a shape of the conductive pattern, the antenna device may enjoy increased degree of design freedom. The conductive pattern may be formed not only on the surface of the shaft but also on a surface of a non-conductive material included in the hinge section.

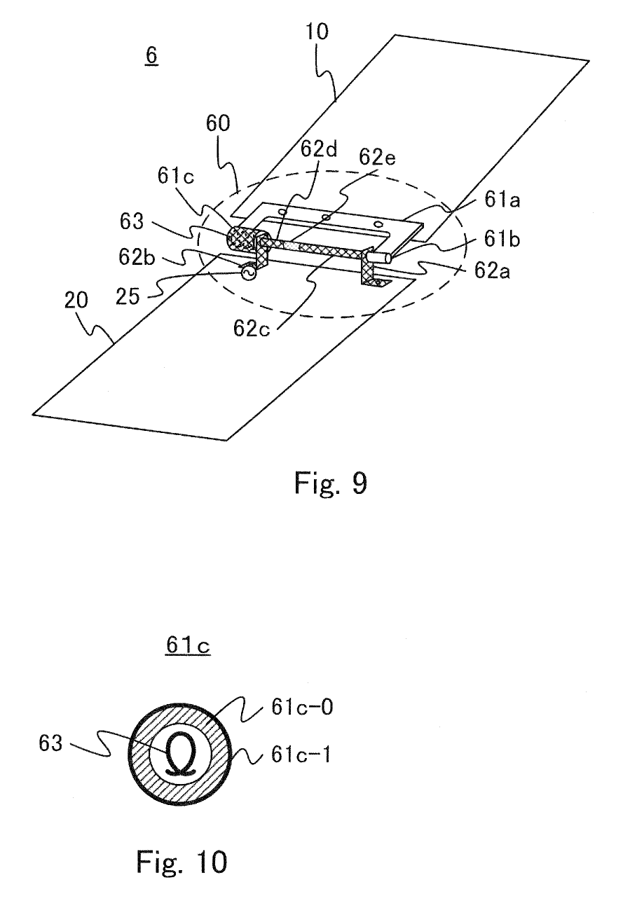

A third embodiment of the present invention will be described with reference to FIGS. 9-12. FIG. 9 is a perspective view showing a configuration of a main portion and connections of a radio apparatus 6 of the third embodiment. The radio apparatus 6 is formed by the first section 10 and the second section 20 which are same as the ones of the first embodiment, and are pivotally connected to each other by a hinge section 60 (encircled by a dotted ellipse) so as to relatively rotate. The second section 20 contains the printed board 21 which is a same as the one of the first embodiment, being not shown in FIG. 9 though.

The hinge section 60 has a first section side material 61 (shortened as the first material 61) and a second section side material 62 (shortened as the second material 62). The first material 61 has a first fitting portion 61a shaped into a flat plate and having fitting holes, a bearing portion 61b shaped into, e.g., a cylinder on a right side, and a spring portion 61c shaped into, e.g., a cylinder on a left side.

The first fitting portion 61a and the bearing portion 61b are made of non-conductive material. The spring portion 61c is partially made of conductive material as described later with reference to FIG. 10. It may be considered that the first material 61 is a same as the first material 31 of the first embodiment except for the above partial conductivity of the spring portion 61c.

The second material 62 has a second fitting portion 62a, a second fitting portion 62b, a shaft conductive portion 62d and a shaft non-conductive portion 62e. The second material 62 is a same as the second material 32 of the first embodiment.

FIG. 10 is a cross section of the spring portion 61c in a plane perpendicular to a face of the second section 20 and parallel to a longer side of the second section 20. The spring portion 61c is formed to have a non-conductive portion 61c-0 being hollow inside, e.g., shaped into a hollow cylinder, and a conductive portion 61c-1 formed, e.g., plated on an outer surface of the hollow inside. The spring portion 61c accommodates a spiral shaped spring 63 in the hollow inside of the non-conductive portion 61c-0. The spring portion 61c accommodates a left-hand end (not shown in FIG. 9) of the shaft conductive portion 62d shown in FIG. 9 penetrating the spiral of the spring 63.

Depending on the structure describe d above, the hinge section 60 may allow the first section 10 and the second section 20 to relatively rotate, and may give a moderate resistance or operational feeling while the relative rotation.

The second section 20 is provided with an antenna feeding circuit, not shown in FIG. 9, which may feed the second fitting portion 62b made of conductive material and the conductive portion 61c-1 of the spring portion 61c. The conductive portion 61c-1 of the spring portion 61c then works as an antenna element. As the non-conductive portion 61c-0 exists between the conductive portion 61c-1 and the spring 63, a change of a shape of the spring 63 may less affect antenna characteristics.

To electrically connect the first section 10 and the second section 20, a connection material (not shown) is provided through the hinge section 60, and preferably goes through a portion of the hinge section 60 near the second fitting portion 62a and the shaft conductive portion 62c.

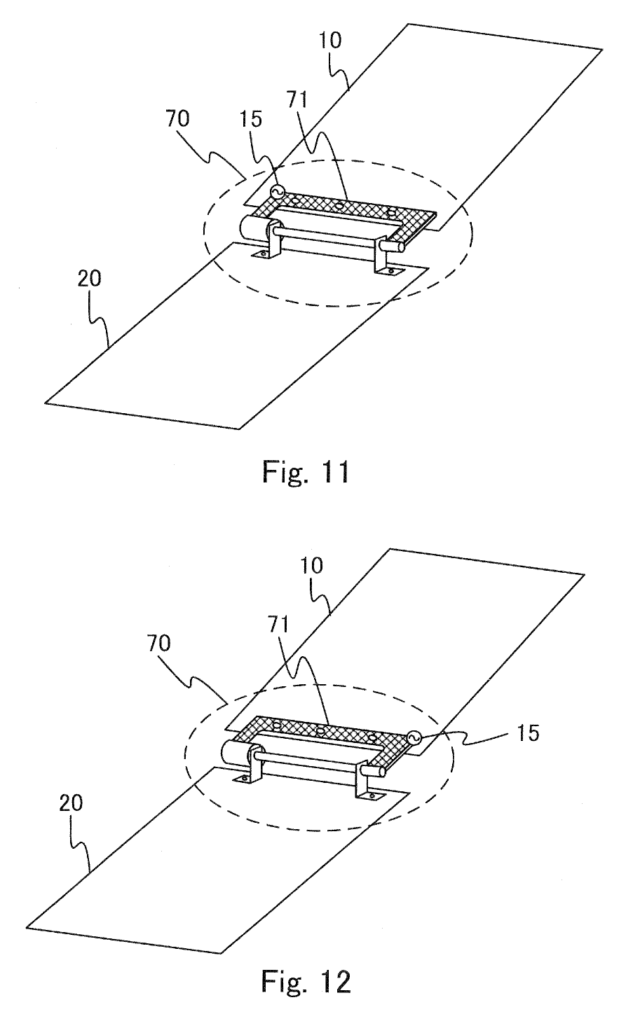

FIG. 11 and FIG. 12 are perspective views each of which shows a main portion and a connection of a radio apparatus modified from the above embodiments. The radio apparatus shown in FIG. 11 or FIG. 12 has the first section 10 and the second section 20 which are same as the ones of the first embodiment, and are pivotally connected to each other by a hinge section 70 (encircled by a dotted ellipse) so as to relatively rotate.

The hinge section 70 has a first section side material 71 (shortened as the first material 71) and is different from the hinge sections of the above embodiments in that a conductive pattern is formed, e.g., plated on an outer surface of a main portion of the first material 71 so as to form an antenna element to be fed at a feed portion 15 provided on a left side in FIG. 11. FIG. 12 shows a case where the feed portion 15 is provided on a right side. In this way, the first material 71 may be used as the antenna element.

According to the third embodiment of the present invention described above, another effect may be obtained that the material different from the ones of the first and second embodiments may be used as the antenna element.

In the above descriptions of the embodiments, the configurations, shapes, connections or positional relations of the portions are considered as exemplary only, and thus may be variously modified within the scope of the present invention. The housing structure of the radio apparatus is, e.g., not limited to the clamshell type, and the present invention may be applied to radio apparatus of any kind of housing structure in which two housing sections are pivotally connected so as to relatively rotate.

The particular hardware or software implementation of the pre-sent invention may be varied while still remaining within the scope of the present invention. It is therefore to be understood that within the scope of the appended claims and their equivalents, the invention may be practiced otherwise than as specifically described herein.

What is claimed is:

1. A radio apparatus, comprising.
a first housing section;
a second housing section;
a printed board contained in the second housing section, the printed board being provided with an antenna feeding circuit;
a hinge section pivotally connecting the first housing section and the second housing section to each other so as to relatively rotate the first housing section and the second housing section, the hinge section including a spring, the hinge section including a non-conductive portion, the hinge section including a conductive portion other than the spring, the conductive portion connected to the antenna feeding circuit.

2. The radio apparatus of claim 1, wherein
the hinge section includes a shaft configured to work as an axis of the relative rotation,
the spring is spiral shaped and arranged in such a manner that an end of the shaft penetrates the spiral of the spring, and
the conductive portion includes a portion of the shaft positioned on a side far from the spring.

3. The radio apparatus of claim 1, wherein
the hinge section includes a shaft configured to work as an axis of the relative rotation,
the spring is spiral shaped and arranged in such a manner that an end of the shaft penetrates the spiral of the spring, and
the conductive portion includes a conductive pattern formed on a surface of the non-conductive portion positioned on a side far from the spring.

4. The radio apparatus of claim 1 further comprising a connection material arranged to go through a portion of the hinge section near the spring.

5. The radio apparatus of claim 2 further comprising a connection material arranged to go through a portion of the hinge section near the spring.

6. The radio apparatus of claim 3 further comprising a connection material arranged to go through a portion of the hinge section near the spring.

7. The radio apparatus of claim 1, wherein
the hinge section includes a shaft configured to work as an axis of the relative rotation,
the non-conductive portion is at least partially hollow inside,
the spring is accommodated in the hollow inside of the non-conductive portion, the spring being spiral shaped and arranged in such a manner that an end of the shaft penetrates the spiral of the spring, and
the conductive portion includes a conductive pattern formed on an outer surface of the hollow inside of the non-conductive portion.

8. A radio apparatus having a first housing section and a second housing section, comprising:
means for pivotally connecting the first housing section and the second housing section to each other so as to relatively rotate the first housing section and the second housing section around an axis of rotation;
means for generating resistance power to the relative rotation of the first housing section and the second housing section; and
means for feeding as an antenna element a conductive portion of the axis of the rotation.

9. An antenna device adapted for a radio apparatus having a first housing section and a second housing section pivotally connected by a hinge section, comprising:
an antenna element formed by a conductive portion of the hinge section, the conductive portion is connected to an antenna feeding circuit provided in one of the first housing section and the second housing section.

10. The antenna device of claim 8, wherein
the hinge section includes a spiral shaped spring and a shaft configured to work as an axis of relative rotation between the first housing section and the second housing section, the spring being arranged in such a manner that an end of the shaft penetrates the spiral of the spring, and
the conductive portion forming the antenna element includes a portion of the shaft positioned on a side far from the spring.

11. The antenna device of claim 8, wherein
the hinge section includes a non-conductive portion, the hinge section including a spiral shaped spring and a shaft configured to work as an axis of relative rotation between the first housing section and the second housing section, the spring being arranged in such a manner that an end of the shaft penetrates the spiral of the spring, and
the conductive portion forming the antenna element includes a conductive pattern formed on a surface of the non-conductive portion positioned on a side far from the spring.

12. The antenna device of claim 8 wherein
the hinge section includes a non-conductive portion being at least partially hollow inside, the hinge section accommodating a spiral shaped spring in the hollow inside, the hinge section including a shaft configured to work as an axis of relative rotation between the first housing section and the second housing section, the spring being arranged in such a manner that an end of the shaft penetrates the spiral of the spring, and
the conductive portion forming the antenna element includes a conductive pattern formed on an outer surface of the hollow inside of the non-conductive portion.
